(19) United States
(12) Patent Application Publication
(10) Pub. No.: US 2025/0225537 A1
(43) Pub. Date: Jul. 10, 2025

(54) INDUSTRY TRENDS ENGINE INCORPORATED IN AN ENTERPRISE RESOURCE PLATFORM

(71) Applicant: Wells Fargo Bank, N.A., San Francisco, CA (US)

(72) Inventors: Greg J. Hansen, Palo Alto, CA (US); Shelli Ulrich, San Francisco, CA (US); Alison N. Shaw, San Francisco, CA (US); Nagaraja R. Chennur, San Francisco, CA (US)

(73) Assignee: Wells Fargo Bank, N.A., San Francisco, CA (US)

(21) Appl. No.: 18/404,125

(22) Filed: Jan. 4, 2024

(51) Int. Cl. G06Q 30/0201

(52) U.S. Cl. CPC G06Q 30/0201

(57) ABSTRACT

Systems and methods are described herein for incorporating an industry trends engine into an enterprise resource platform. Such systems and methods may use an institution computing system to establish a connection with an embedded service within an enterprise resource of a first entity. After authenticating a user of the first entity accessing the embedded service, the system retrieves first data relating to other entities having one or more attributes corresponding to the attributes of the first entity. Using throughput analytics based on the first data and a count of second entities, the system determines an individual throughput for the first entity. The individual throughput is compared to a current input of the first entity, and a purchase recommendation based on the comparison is provided to the user via a user interface of the enterprise resource.

### TECHNICAL FIELD

The present disclosure relates to industry trends. More specifically, the present disclosure relates to aggregating industry-wide data to provide relevant insights to dealers through an enterprise resource platform.

### BACKGROUND

Some dealers may access their own inventory and payment patterns to gather insight into industry trends. Such information may be limited, and may thus not provide a holistic view of the industry as a whole.

### SUMMARY

One embodiment relates to a computer-implemented method. The method includes establishing a connection with an embedded service within an enterprise resource planning (ERP) resource of a first entity. Once the connection is established, a user of the first entity accessing the embedded service via the ERP resource is authenticated. First data including information relating to other entities having one or more attributes corresponding to attributes of the first entity, geographic data corresponding to the first entity, and metrics associated with an entity category corresponding to the first entity and the other entities are retrieved from one or more data sources. Based on the first data, a first artificial intelligence (AI) model forecasts throughput analytics for a time window. A count of second entities which satisfy a selection criteria corresponding to the entity category and the geographic data corresponding to the first entity is determined. According to the count of second entities and the throughput analytics for the time window, a second AI model determines a predicted individual throughput for the first entity. Second data corresponding to a current input corresponding to the throughput analytics and historical inputs is received. Finally, a graphical user interface including a recommendation corresponding to a current throughput based on the individual throughput and the current input is generated for rendering via the embedded service within a user interface of the ERP resource.

In some embodiments, the method further includes enrolling the first entity with the embedded service. A profile associated with the first entity is tagged with one or more tags based on the attributes of the first entity. The first entity is then assigned to the entity category based on the one or more tags applied to the profile. In some embodiments, the throughput analytics may include a regional demand associated with a resource provided by the first entity and the second entities selected which satisfy the selection criteria.

In some embodiments, the one or more data sources may include a first data source of an institution computing system and a second data source of a third-party computing system. The first data source stores at least some of the first data associated with the first entity, and second data corresponding to at least some of the second entities. The first AI model may be trained on data from a plurality of entities, at least some of which are assigned to the entity category of the first entity. The first AI model forecasts throughput analytics using the first data retrieved from the first data source and the second data source. In some embodiments, the graphical user interface includes a range including the recommendation. In some embodiments, the graphical user interface may include a heat map associated with the geographic data corresponding to the first entity. In some embodiments, the second AI model generates an output corresponding to the graphical user interface for rendering via the embedded service within the user interface of the ERP resource. In some embodiments, the second data corresponding to the current input is received from at least one of the ERP resource or from a data source of the one or more data sources maintained by an institution computing system.

Another embodiment relates to an institution computing system including a processing circuit including one or more processors and memory, the memory storing instructions that, when executed, cause the processing circuit to establish a connection with an embedded service of the institution computing system within an enterprise resource of a first entity. The instructions further cause the processing circuit to authenticate a user of the first entity accessing the embedded service via the enterprise resource. The instructions further cause the processing circuit to retrieve first data from one or more data sources, wherein the first data comprises information relating to other entities having one or more attributes corresponding to attributes of the first entity, geographic data corresponding to the first entity, and metrics associated with an entity category corresponding to the first entity and the other entities. The instructions further cause the processing circuit to forecast, by a first artificial intelligence (AI) model of the institution computing system, throughput analytics for a time window based on the first data. The instructions further cause the processing circuit to determine a count of second entities which satisfy a selection criteria associated with the first entity, the selection criteria corresponding to the entity category of the first entity and the geographic data corresponding to the first entity. The instructions further cause the processing circuit to determine, by a second AI model of the institution computing system, a predicted individual throughput for the first entity, according to the count of second entities and the throughput analytics for the time window. The instructions further cause the processing circuit to receive second data corresponding to a current input corresponding to the throughput analytics, and historical inputs. The instructions further cause the processing circuit to generate a graphical user interface for rendering via the embedded service within a user interface of the enterprise resource, the graphical user interface comprising a recommendation corresponding to a current throughput based on the predicted individual throughput and the current input.

Another embodiment relates to a non-transitory computer-readable medium storing instructions that, when executed by one or more processors of a processing circuit, cause the processing circuit to establish a connection with an embedded service of the institution computing system within an enterprise resource of a first entity. The instructions further cause the processing circuit to authenticate a user of the first entity accessing the embedded service via the enterprise resource. The instructions further cause the processing circuit to retrieve first data from one or more data sources, wherein the first data comprises information relating to other entities having one or more attributes corresponding to attributes of the first entity, geographic data corresponding to the first entity, and metrics associated with an entity category corresponding to the first entity and the other entities. The instructions further cause the processing circuit to forecast, by a first artificial intelligence (AI) model of the institution computing system, throughput analytics for a time window based on the first data. The instructions further cause the processing circuit to determine a count of second entities which satisfy a selection criteria associated with the first entity, the selection criteria corresponding to the entity category of the first entity and the geographic data corresponding to the first entity. The instructions further cause the processing circuit to determine, by a second AI model of the institution computing system, a predicted individual throughput for the first entity, according to the count of second entities and the throughput analytics for the time window. The instructions further cause the processing circuit to receive second data corresponding to a current input corresponding to the throughput analytics, and historical inputs. The instructions further cause the processing circuit to generate a graphical user interface for rendering via the embedded service within a user interface of the enterprise resource, the graphical user interface comprising a recommendation corresponding to a current throughput based on the predicted individual throughput and the current input.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

Before turning to the Figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

FIG. 1 shows a block diagram of an artificial intelligence (AI) system, according to an exemplary embodiment.

FIG. 2 shows a block diagram of an AI model of the AI system of FIG. 1, according to an exemplary embodiment.

FIG. 3 shows a block diagram of an institution computing system, according to an exemplary embodiment.

FIG. 4 shows an example graphical user interface (GUI) generated by the system of FIG. 1, according to an exemplary embodiment.

FIG. 5 shows another example GUI generated by the system of FIG. 1, according to an exemplary embodiment.

FIG. 6 shows a heat map generated by the system of FIG. 1, according to an exemplary embodiment.

FIG. 7 shows a flowchart of an example method of generating and presenting industry trends via an enterprise resource, according to an exemplary embodiment.

### DETAILED DESCRIPTION

Referring generally to the figures, systems and methods surrounding an industry trends engine incorporated in an enterprise resource platform are shown. Without having access to industry-wide trends and analytics, business entities face considerable uncertainty when assessing their inventory levels and projected sales. Entities in a given industry can analyze their own operational patterns and trends over time, but analyzing the activity of their competitors across the industry requires extensive research. Additionally, without access to the trends of other entities which operate in a different capacity within the industry (e.g., manufacturers, wholesalers, etc.), business entities are missing critical insight into the overall performance of the industry and how their operation might be affected by such trends.

By retrieving and presenting relevant data from across the industry, the industry trends engine presents a comprehensive analysis of historical, current, and future insights within the industry. Furthermore, the industry trends engine incorporated into the enterprise resource platform provides a precise recommendation to avoid over-ordering and optimizes orders through advanced predictive capabilities based on the retrieved data. Users of this system obtain a complete view of industry trends and are presented with an option to take appropriate action in response to these trends all within their enterprise resource, creating a technological improvement on existing methods.

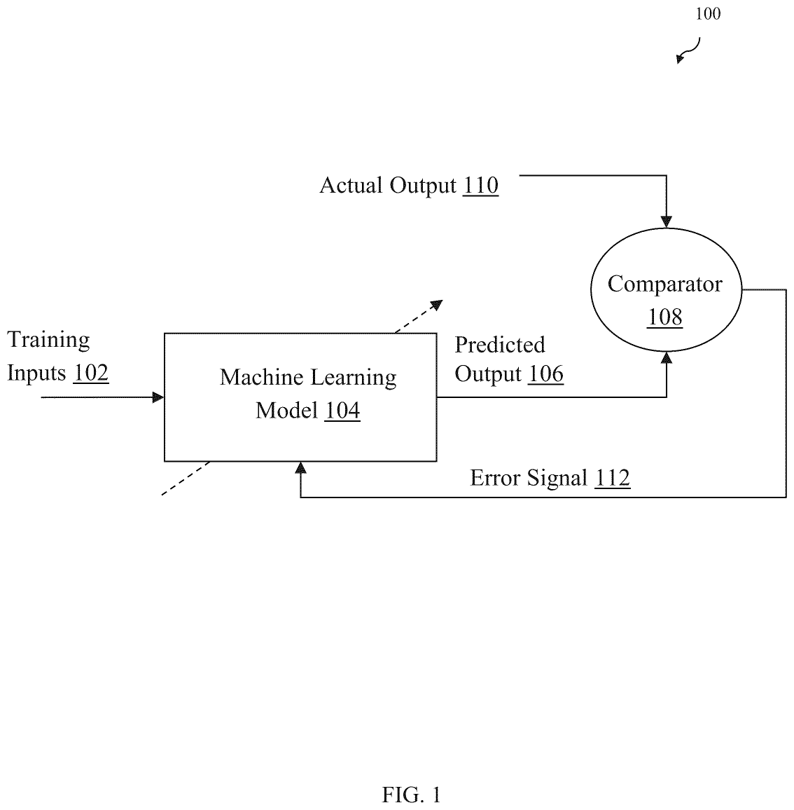

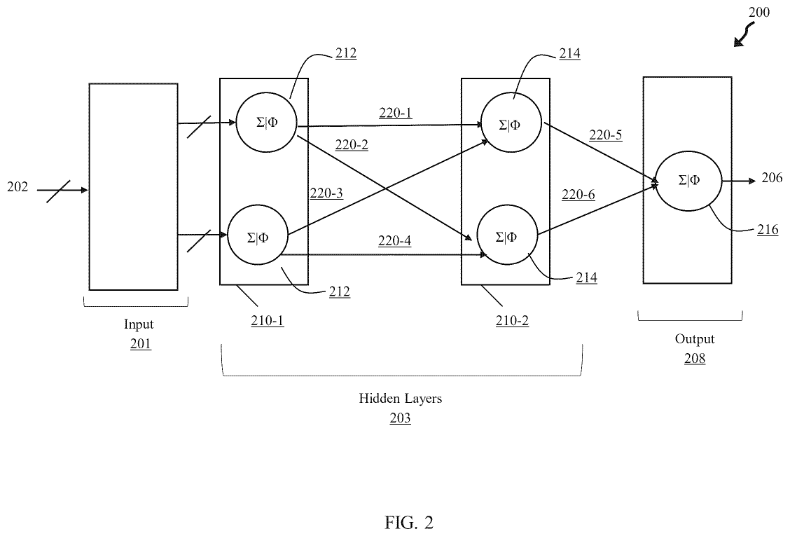

Referring generally to FIG. 1 and FIG. 2, the systems and methods described herein may use, implement, or otherwise leverage various machine learning algorithms and/or artificial intelligence solutions. Examples of such solutions are described with reference to FIG. 1 and FIG. 2. While these examples are described, it is noted that additional or alternative machine learning solutions may be implemented by the systems and methods described herein.

Referring to FIG. 1, a block diagram of an example system using supervised learning (e.g., artificial intelligence (AI) system 100), is shown. Supervised learning is a method of training a machine learning model given input-output pairs. An input-output pair is an input with an associated known output (e.g., an expected output).

A machine learning model 104 may be trained on known input-output pairs such that the machine learning model 104 can learn how to predict known outputs given known inputs. Once the machine learning model 104 has learned how to predict known input-output pairs, the machine learning model 104 can operate on unknown inputs to predict an output.

The machine learning model 104 may be trained based on general data and/or granular data (e.g., data based on a specific user) such that the machine learning model 104 may be trained specific to a particular user.

Training inputs 102 and actual outputs 110 may be provided to the machine learning model 104. Training inputs 102 may include account data associated with an entity (e.g., retrieved by authenticator 315, as described below), economic data, socioeconomic data, social trends, geographical data, and the like. The training inputs 102 may further include a competitor count (e.g., determined by the categorization engine 318, as described below). Actual outputs 110 may include overall market performance, sales performance of one or more entities, industry trends for an entity category of the one or more entities, realized current market demand for a particular product or product-type, and the like.

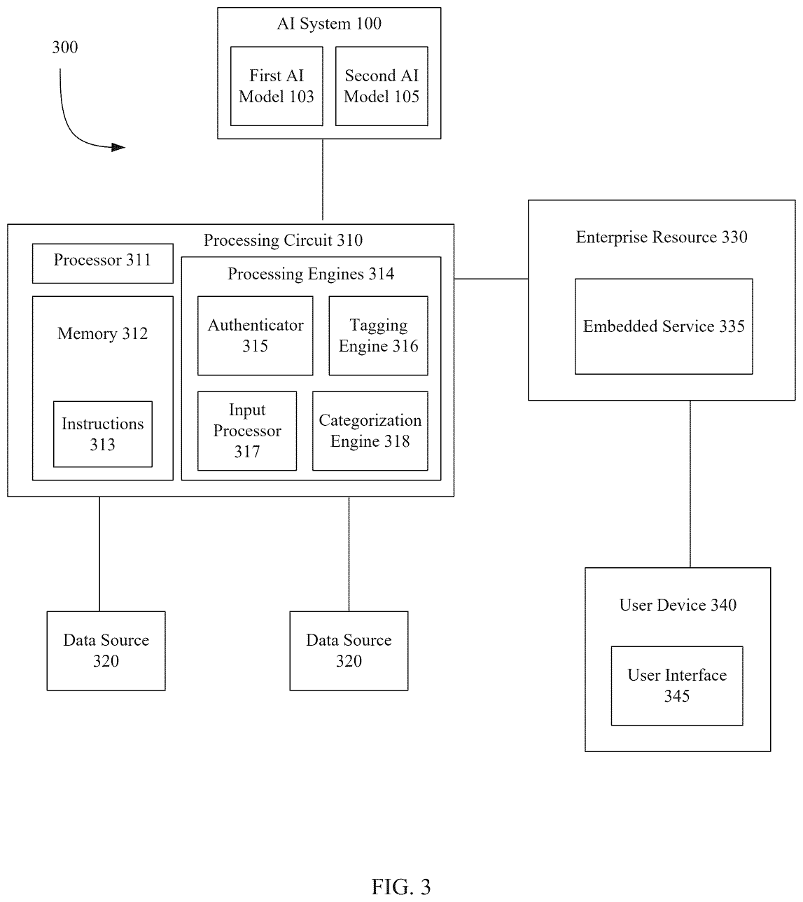

The training inputs 102 and the actual outputs 110 may be received from any of the data repositories (e.g., one or more data sources 320, as described below with reference to FIG. 3). For example, a data repository may contain internal data from the financial institution (e.g., account information, transaction history, financial trends, etc.). The data repository may also contain data associated with third-party sources (e.g., private sector finance reports, government reports, census reports, etc.). Thus, the machine learning model 104 may be trained to predict industry trends and enterprise recommendations based on the training inputs 102 and actual outputs 110 used to train the machine learning model 104.

The AI system 100 may include one or more machine learning models 104. In an embodiment, a first machine learning model 104 may be trained to predict data relating to throughput analytics (e.g., demand for a particular product or product-type). For example, the first machine learning model 104 may use the training inputs 102, such as an entity category associated with an entity (e.g., determined by the categorization engine 318, as described below) and internet trends (e.g., from a third-party data source) relating to a product or product-type associated with that entity category (e.g., the product or product type identified by the tagging engine 316, as described below), to predict outputs 106, such as the demand for one or more products or product-types associated with that entity category, by applying the current state of the first machine learning model 104 to the training inputs 102. A comparator 108 may compare predicted outputs 106 to the actual outputs 110 to determine an amount of error or differences. For example, the predicted demand (e.g., predicted output 106) may be compared to the actual demand as indicated on economic reports, financial statements, sales histories, etc. (e.g., actual output 110).

In other embodiments, a second machine learning model 104 may be trained to make one or more recommendations to the user based on the predicted output from the first machine learning model 104. For example, the second machine learning model 104 may use the training inputs 102, such as the competitor count, to predict outputs 106, such as an individualized demand associated with a specific entity, by applying the current state of the second machine learning model 104 to the training inputs 102. The comparator 108 may compare the predicted outputs 106 to actual outputs 110, such as the sales performance of the particular entity, to determine an amount of error or differences.

The actual outputs 110 may be determined based on historic data of recommendations made to the user, such as the individualized demand predicted by the second machine learning model 104. In an illustrative non-limiting example, the realized current market demand may be determined by aggregating the individualized demands associated with a particular product or product-type for a given time period corresponding to the time period of the realized current market demand.

In some embodiments, a single machine leaning model 104 may be trained to make one or more recommendations to the user based on current user data received from one or more enterprise resources 330. That is, a single machine leaning model may be trained using the training inputs 102, such as account data associated with an entity (e.g., retrieved by authenticator 315, as described below), economic data, socioeconomic data, social trends, geographical data, and the like, to predict outputs 106, such as a predicted individualized demand for an entity, by applying the current state of the machine learning model 104 to the training inputs 102. The comparator 108 may compare the predicted outputs 106 to the actual outputs 110, such as the sales performance of the particular entity, to determine an amount of error or differences. The actual outputs 110 may be determined based on historic data associated with the recommendation to the user.

During training, the error (represented by an error signal 112) determined by the comparator 108 may be used to adjust the weights in the machine learning model 104 such that the machine learning model 104 changes (or learns) over time. The machine learning model 104 may be trained using a backpropagation algorithm, for instance. The backpropagation algorithm operates by propagating the error signal 112. The error signal 112 may be calculated each iteration (e.g., each pair of training inputs 102 and associated actual outputs 110), batch and/or epoch, and propagated through the algorithmic weights in the machine learning model 104 such that the algorithmic weights adapt based on the amount of error. The error is minimized using a loss function. Non-limiting examples of loss functions may include the square error function, the root mean square error function, and/or the cross-entropy error function.

The weighting coefficients of the machine learning model 104 may be tuned to reduce the amount of error, thereby minimizing the differences between (or otherwise converging) the predicted output 106 and the actual output 110. The machine learning model 104 may be trained until the error determined at the comparator 108 is within a certain threshold (or a threshold number of batches, epochs, or iterations have been reached). The trained machine learning model 104 and associated weighting coefficients may subsequently be stored in a memory 116 or other data repository (e.g., a database) such that the machine learning model 104 may be employed on unknown data (e.g., not training inputs 102). Once trained and validated, the machine learning model 104 may be employed during a testing (or an inference phase). During testing, the machine learning model 104 may ingest unknown data to predict future data (e.g., inventory levels, purchase recommendations, sales rates, market demands, and the like).

Referring to FIG. 2, a block diagram of a simplified neural network model 200 is shown. The neural network model 200 may include a stack of distinct layers (vertically oriented) that transform a variable number of inputs 202 being ingested by an input layer 204, into an output 206 at the output layer 208.

The neural network model 200 may include a number of hidden layers 210 between the input layer 204 and output layer 208. Each hidden layer has a respective number of nodes (212, 214 and 216). In the neural network model 200, the first hidden layer 210-1 has nodes 212, and the second hidden layer 210-2 has nodes 214. The nodes 212 and 214 perform a particular computation and are interconnected to the nodes of adjacent layers (e.g., nodes 212 in the first hidden layer 210-1 are connected to nodes 214 in a second hidden layer 210-2, and nodes 214 in the second hidden layer 210-2 are connected to nodes 216 in the output layer 208). Each of the nodes (212, 214 and 216) sum up the values from adjacent nodes and apply an activation function, allowing the neural network model 200 to detect nonlinear patterns in the inputs 202. Each of the nodes (212, 214 and 216) are interconnected by weights 220-1, 220-2, 220-3, 220-4, 220-5, 220-6 (collectively referred to as weights 220). Weights 220 are tuned during training to adjust the strength of the node. The adjustment of the strength of the node facilitates the neural network's ability to predict an accurate output 206.

In some embodiments, the output 206 may be one or more numbers. For example, the output 206 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

Referring to FIG. 3, a block diagram of a system 300 (e.g., an institution computing system) for incorporating an industry trends engine into an enterprise resource platform according to an example embodiment is shown. In brief overview, the system 300 includes a processing circuit 310 communicably coupled to one or more data sources 320, the AI system 100, an enterprise resource 330, and a user device 340. The system 300 is affiliated with a financial institution, such as a bank. As described in greater detail below, the system 300 may be configured to establish a establish a connection with an embedded service (e.g., embedded service 335) of the system 300 within the enterprise resource 330 of a first entity. The system 300 may be configured to authenticate a user of the first entity accessing the embedded service 335 via the enterprise resource 330. The system 300 may be configured to retrieve first data from one or more data sources (e.g., one or more data sources 320). The first data may include information relating to other entities having one or more attributes corresponding to attributes of the first entity, geographic data corresponding to the first entity, and metrics associated with an entity category corresponding to the first entity and the other entities. The system 300 may be configured to forecast, by a first artificial intelligence (AI) model (e.g., the machine learning model 104) of the system 300, throughput analytics for a time window based on the first data. The system 300 may be configured to determine a count of second entities which satisfy a selection criteria associated with the first entity, where the selection criteria corresponds to the entity category of the first entity and the geographic data corresponding to the first entity. The system 300 may be configured to determine, by a second AI model (e.g., the machine learning model 104) of the system 300, a predicted individual throughput for the first entity, according to the count of second entities and the throughput analytics for the time window. The system 300 may be configured to receive second data corresponding to a current input corresponding to the throughput analytics, and historical inputs. The system 300 may be configured to generate a graphical user interface (e.g., interface 400, interface 500) for rendering via the embedded service 335 within a user interface (e.g., user interface 345) of the enterprise resource 330. The graphical user interface may include a recommendation corresponding to a current throughput based on the predicted individual throughput and the current input.

The AI system 100, described in greater detail above with reference to FIGS. 1 and 2, may include a first AI model 103 and a second AI model 105. In some embodiments, the first AI model 103 may be the first machine learning model 104, as described above. In some embodiments, the second AI model 105 may be the second machine learning model 104, as described above. In this regard, the AI system 100 may include a cascaded machine learning model, in which the output of one machine learning model is fed as an input to a second machine learning model.

The processing circuit 310 may include memory 312 communicably coupled to one or more processors 311. In some embodiments, the processing circuit 310 may be configured to implement various processing engines 314 (e.g., by the processor(s) 311 executing corresponding instructions in memory 312). The processing engines 314 may be or include any device, component, element, or hardware designed or configured to perform various dedicated functions associated therewith. In some embodiments, the processing engines 314 may include an authenticator 315, a tagging engine 316, an input processor 317, and a categorization engine 318, all of which are described in greater detail below. The memory 312 stores instructions 313 configured to, for example, cause the processing circuit 310 to perform the operations corresponding to the respective processing engines 314.

The one or more processors 311 may be implemented or performed with a general-purpose single- or multi-chip processor, a digital signal processor (DSP), an application specific integrated circuit (ASIC), one or more field programmable gate array (FPGAs), or other suitable electronic processing components. A general-purpose processor may be a microprocessor, or, any conventional processor, or state machine. A processor 311 also may be implemented as a combination of computing devices, such as a combination of a DSP and a microprocessor, a plurality of microprocessors, one or more microprocessors in conjunction with a DSP core, or any other such configuration. In some embodiments, the one or more processors 311 may be shared by multiple circuits (e.g., the circuits of the processor may comprise or otherwise share the same processor which, in some example embodiments, may execute instructions stored, or otherwise accessed, via different areas of memory). Alternatively or additionally, the one or more processors 311 may be structured to perform or otherwise execute certain operations independent of one or more co-processors. In other example embodiments, two or more processors 311 may be coupled via a bus to enable independent, parallel, pipelined, or multi-threaded instruction execution. All such variations are intended to fall within the scope of the present disclosure.

The one or more processing engines 314 may include the authenticator 315, as shown in processing circuit 310. The authenticator 315 may be or include any device, component, element, or hardware designed or configured to grant a user access to the system 300, where the user has an account associated with the financial institution. In some embodiments, the authenticator 315 may include a third-party authenticator application, an internal log-in portal, a biometric scanning device, etc. The authenticator 315 may be communicably coupled to the one or more processors and the memory 312 of the processing circuit 310.

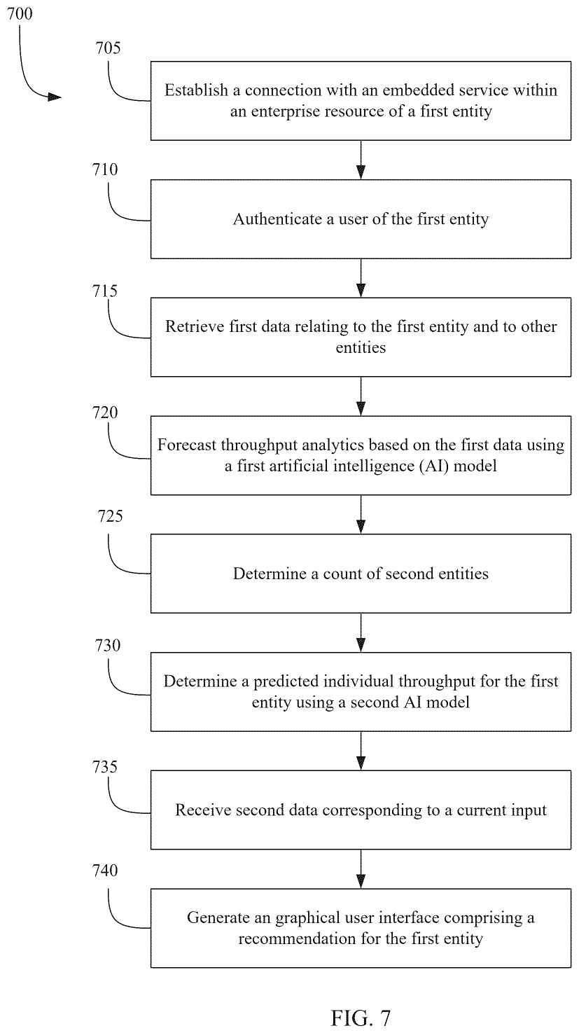

The authenticator 315 may grant a user access to the embedded service 335 of the institution computing system 300 by any of a plurality of authenticating methods, as described below with reference to FIG. 7. For example, a user may attempt to access the embedded service 335 from a user device via an enterprise resource planning (ERP) application associated with the institution computing system 300. The authenticator 315 may receive one or more credentials (e.g., a username, password, a biometric scan, a pin code, etc.) and match the one or more credentials received from the user device with one or more credentials associated with a user account stored in the memory 312. Upon matching the credentials, the authenticator 315 may be configured to grant the user access to the embedded service 335. In some embodiments, the authenticator 315 may further identify, from the memory 312, that the customer account indicates a particular role of the user (e.g., a store manager, a sales associate, a company executive, etc.). The authenticator 315 may restrict the access to the embedded service 335 depending on one or more access rights associated with the role of the user. The access rights may be predefined by the financial institution and stored in the memory 312.

The one or more processing engines 314 may include the tagging engine 316, as shown in processing circuit 310. The tagging engine 316 may be or include any device, component, element, or hardware designed or configured to tag an entity according the one or more attributes (e.g., tags). The one or more tags may include a geographic location of the entity, an entity type (e.g., wholesaler, boutique, franchise, online store, etc.), an entity size, an input (e.g., inventory, product, product-type, resource, etc.), and the like. The tagging engine 316 may be communicably coupled to the one or more processors and the memory 312 of the processing circuit 310.

The tagging engine 316 may be designed or configured to tag the entity based on data from various information repositories or data sources. For example, the tagging engine 316 may retrieve the one or more tags from the user account information retrieved by the authenticator 315. The tagging engine 316 may retrieve the geographic location of the entity from a location indicator (e.g., GPS data) of a user device from which the entity is accessing the embedded service 335. The tagging engine 316 may determine the entity size from records (e.g., tax records, financial records, etc.) associated with the entity stored in an internal database (e.g., the one or more data sources 320). The tagging engine 316 may also identify the one or more tags from a third-party data source (e.g., an entity website, a business journal or other publication, government records, etc.). For example, the entity website may indicate that the entity does not have any brick-and-mortar locations. The tagging engine 316 may retrieve this information from the one or more data sources 320 and tag the entity as a “web-based entity.” As another example, the tagging engine 316 may retrieve a transaction history associated with an entity from an internal data source (e.g., the one or more data sources 320, the input processor 317). From the transaction history, the tagging engine 316 may identify one or more products or product types sold by the entity and thereby tag the entity with a particular input.

The processing engines 314 may include the input processor 317, as shown in processing circuit 310. The input processor 317 may be or include any device, component, element, or hardware designed or configured to process input data (e.g., inventory levels, purchase orders, sales history, etc.) related to an entity. The input processor 317 may be communicably coupled to the one or more processors and the memory 312 of the processing circuit 310. The input processor 317 may be configured to adjust the input data related to an entity as inventory levels change. For example, the input processor 317 may determine an initial inventory level by identifying a quantity of products on a purchase order from a receipt stored in an internal data source (e.g., one or more data sources 320). The input processor 317 can then, at any given time, subtract a quantity of product sales identified on a transaction history stored in the internal data source to determine a current inventory. In this regard, the input processor 317 may be configured to maintain a ledger of inventory, which is added to as new inventory is procured and is reduced as inventory is sold off.

In some embodiments, the input processor 317 may be configured to compare a current inventory of an entity against a current inventory of one or more other entities. In some embodiments, the one or more other entities may be tagged by the tagging engine 316 with one or more of the same attributes as the entity. The input processor 317 may also be configured to provide a purchase recommendation to the entity. The purchase recommendation may include a quantity of a product or product-type to acquire. In some embodiments, the recommendation may be a precise quantity (e.g., 30 units) or a range (e.g., 25-35 units). The recommendation may be determined by the input processor 317 based on the current inventory and a predicted individual throughput (e.g., individual demand) determined by an Al model (e.g., the second machine learning model 104, the second AI model 105), as described in greater detail below. For example, the recommendation may be determined by performing a calculation of subtracting the current inventory from the predicted individual throughput.

The processing engines 314 may include the categorization engine 318, as shown in processing circuit 310. The categorization engine 318 may be or include any device, component, element, or hardware designed or configured to categorize entities according to at least one of the one or more attributes tagged by the tagging engine 316. The categorization engine 318 may be communicably coupled to the one or more processors and the memory 312 of the processing circuit 310. For example, the categorization engine 318 may determine an entity category of the entity based on an input tagged to the entity by the tagging engine 316 and identifying, from the memory 312, other entities that have been tagged by the tagging engine 316 with the same input. The categorization engine 318 can then assign the entity to the entity category assigned to the other entities that have been tagged with the same input. In some embodiments, the categorization engine 318 may identify a plurality of inputs associated with an entity category. Upon the tagging engine 316 tagging an entity with any one of the plurality of inputs, the categorization engine 318 may assign the entity to that entity category. For example, the tagging engine 316 may identify a product called “CANOE” from a transaction history associated with an entity. The categorization engine 318 may identify “CANOE” as one of a plurality of inputs in an “outdoor recreation” entity category. The categorization engine 318 may then assign the entity to the “outdoor recreation” entity category.

In some embodiments, the categorization engine 318 may be configured to create sub-categories within the entity categories. The sub-categories may be additional categories configured to further categorize the entities in an entity category according to one of the one or more attributes assigned by the tagging engine 316. In some embodiments, the sub-category may be at least one of the geographic location, the entity size, the entity type, etc., tagged by the tagging engine 316. The sub-categories may also contain one or more additional sub-categories. For example, after categorizing an entity to an entity category, the categorization engine 318 may further categorize the entities within that entity category by a sub-category of geographic location (e.g., by county, by city, by state, etc.). Within the sub-category of geographic location, the categorization engine 318 may further categorize the entities within that sub-category by an additional sub-category of entity type (e.g., wholesaler, boutique, franchise, etc.).

The processing circuit 310 is also shown to include the memory 312. The memory 312 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 312 may be or include tangible, non-transient volatile memory or non-volatile memory. The memory 312 may also include database components, object code components, script components, or any other type of information structure for supporting the activities and information structures described in the present application. According to an exemplary embodiment, the memory 312 is communicably connected to the one or more processors via the processing circuit 310 and includes computer code for executing (e.g., by the processing circuit 310 and/or the one or more processors) one or more processes described herein.

In some embodiments, the system 300 includes the one or more data sources 320 communicably coupled to the processing circuit 310. In some embodiments, the one or more data sources 320 includes a first data source and a second data source. The first data source may include an internal data source (e.g., internal records of the system 300). The second data source may include an external data source (e.g., from a third-party computing system). For example, the processing circuit 310 may retrieve entity data of an entity enrolled in the financial institution, financial data, historical records, etc., from the first data source. The processing circuit 310 may retrieve data relating to competitors, demographic information of a relevant geographic region, socioeconomic factors, etc., from the second data source.

The processing circuit 310 may be communicably coupled to the enterprise resource 330. The enterprise resource 330 may be or include an enterprise resource planning (ERP) platform, an inventory management system, a dealer management system, etc. The enterprise resource 330 may be or include various systems or applications which are provided to an entity (e.g., by one or more service providers of the enterprise resource 330). The enterprise resource 330 may be configured to facilitate management of resources corresponding to various entities in various industries. The enterprise resource 330 may be implemented on or otherwise hosted on a computing system (e.g., the system 300), such as a discrete server, a group of two or more computing devices/servers, a distributed computing network, a cloud computing network, and/or another type of computing system capable of accessing and communicating using local and/or global networks. Such computing system hosting the enterprise resource 330 may be maintained by a service provider corresponding to the enterprise resource 330. The enterprise resource 330 may be accessible by various computing devices or user devices (e.g., user device 340) associated with an entity responsive to enrollment of the enterprise with the enterprise resource 330, as described in greater detail below.

The enterprise resource 330 may be configured to establish connections with other systems in the system 300 (e.g., the AI system 100, the processing circuit 310, the user device 340, etc.) via a network. In an exemplary embodiment, the enterprise resource 330 may be communicable coupled to an interface (e.g., user interface 345) that displays the content and data communicated from the processing circuit 310. For example, the user interface 145 may include a graphical user interface (e.g., interface 400, interface 500), a mobile user interface, or any other suitable interface that may display the content and data (e.g., associated with products and services of the system 300) to the enterprise resource 330. In this regard, enterprise resource 330, and entities associated with the enterprise resource 330 (e.g., customers, employees, shareholders, policy holders, etc.), may access, view, analyze, etc. the content and data transmitted by the processing circuit 310 remotely using the enterprise resource 330.

The enterprise resource 330 may include an embedded service 335. The embedded service 335 may be or include any device, component, element, or hardware designed or configured to assist an entity enrolled in the embedded service 335 with their management of resources. In some embodiments, the embedded service 335 may include customer relationship management (CRM) applications and/or enterprise resource planning (ERP) applications. The embedded service 335 may be communicably coupled to the user device 340.

The embedded service 335 may be or include, through the CRM applications, applications for establishing leads on new customers, assisting in converting a lead to a sale, planning delivery, and so forth. The embedded service 335 may also be or include, through the ERP applications, include human resources (HR) or payroll applications, marketing applications, customer service applications, operations/project/supply chain management applications, commerce design applications, and the like. The embedded service 335 may include software and/or hardware capable of implementing a network-based or web-based application (e.g., closed-source and/or open-source software like HTML, XML, WML, SGML, PHP, CGI, Dexterity, TypeScript, Node, etc.). Such software and/or hardware may be updated, revised, or otherwise maintained by resource or service providers of the embedded service 335. The embedded service 335 may be accessible by a representative(s) of a small or large business entity, any customer of the institution, and/or any registered user of the products and/or service provided by one or more components of the system 300. As such, the embedded service 335 may be or include a platform (or software suite) provided by one or more service providers which is accessible by an entity having an existing account with the institution.

In some embodiments, a user with a financial account at the financial institution may access the embedded service 335 via the user device 340. As such, the user device 340 may be used in combination with the enterprise resource 330 to communicate with the AI system 100 and the processing circuit 310. In some embodiments, the user device 340 may be a smartphone, a laptop computer, a tablet computer, a desk-top computer, and the like. The user device 340 can include a display, such as, for example, a liquid crystal display (LCD), a light-emitting diode (LED) display, an organic light-emitting diode (OLED) display, or the like. The user device 340 can receive, for example, capacitive or resistive touch input. In some embodiments, the user device may transmit a data payload, via the embedded service 335, to the processing circuit 310 that includes a location identifier (e.g., GPS information) associated with the client computing device 140.

The user device 340 may be configured to display a user interface 345 corresponding to the enterprise resource 330. The user interface 345 may display data from the processing circuit 310 (e.g., via the enterprise resource 330) to the user. The user interface 345 can display at least one or more user or graphical user interfaces (GUIs) (e.g., interface 400, interface 500), as described in greater detail below.

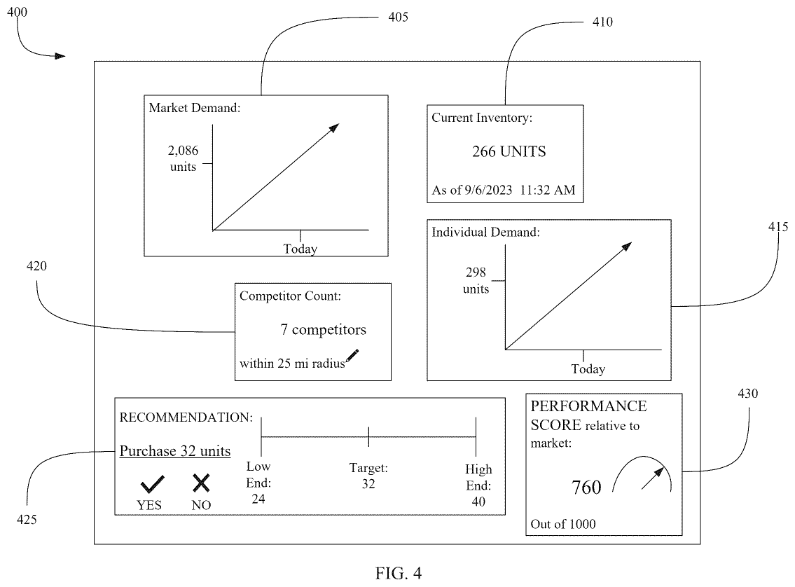

Referring now to FIG. 4, an interface 400 on a user device of an enterprise resource is shown according to an example embodiment. In some embodiments, the interface 400 is generated by the system 300 for display/rendering on the user device 340. In some embodiments, the interface 400 is the GUI generated at step 740 of method 700, as described in greater detail below. In brief, the interface 400 includes graphics or user interface elements displaying information relating to industry trends and entity performance. The graphics displayed on the interface 400 may be customizable by the user or by the institution computing system (e.g., the system 300). In the embodiment shown, the interface 400 displays a market demand 405, a current inventory 410, an individual demand 415, a competitor count 420, a purchase recommendation 425, and a performance score 430.

Still referring to FIG. 4 and in further detail, the interface 400 includes a graphical representation of the market demand 405. In some embodiments, the market demand 405 includes the throughput analytics forecasted at step 740 of method 700, as described below. The graphical representation of the market demand 405 may include an upwards sloping line graph depicting a direct relationship between a number of units and a progression of time. The market demand 405 may be determined by the first AI model 103 based on data from the one or more data sources 320.

The interface 400 includes a display of the current inventory 410. In some embodiments, the current inventory 410 is the current input received at step 735 of method 700, as described below. The current inventory 410 may be determined by the input processor 317 based on data from the enterprise resource 330 (e.g., a purchase order (PO) less products sold, a retailer inventory count, etc.). The current inventory 410 may be associated with a timestamp that is shown on the display of the current inventory 410. In some embodiments, the current inventory 410 is displayed as a unit count corresponding to the timestamp. For example, the current inventory 410 of an entity accessing the embedded service 335 of the enterprise resource 330 may indicate that as of 11:32 AM on Sep. 6, 2023, the current inventory 410 of the entity was 266 units (e.g., products). The unit count may include a number of a specific product or a number of products within a product category. For example, the unit count may indicate a number of speedboats or a number of boats.

The interface 400 includes a graphical representation of the individual demand 415. In some embodiments, the individual demand 415 is the predicted individual throughput determined at step 730 of method 700, as described below. The graphical representation of the individual demand 415 may include an upwards sloping line graph depicting a direct relationship between a number of units and a progression of time. The individual demand 415 may be determined by the second AI model 105 based on data from the one or more data sources 320.

The interface 400 includes a display of the competitor count 420. In some embodiments, the competitor count 420 is the count of second entities determined at step 725 of method 700, as described below. The competitor count 420 may be determined by the categorization engine 318 based on data from the one or more data sources 320, the tagging engine 316, the enterprise resource 330, etc. The competitor count 420 may include a competitor count within a specific radius of the geographic location of the first entity. For example, the interface 400 may display the competitor count 420 within a 25-mile radius of the geographic location of the first entity. In some embodiments, the competitor count 420 includes a selectable element (e.g., a pencil icon, etc.) configured to allow the user to edit the specific radius. The categorization engine 318 may, upon receiving an indication from the enterprise resource 330 that the user is engaging with the selectable element, select the competitor count from one or more entities in a sub-category aligned with the specific radius as edited by the user via the selectable element.

The interface 400 includes a user interface field showing the purchase recommendation 425. In some embodiments, the purchase recommendation 425 is the recommendation generated at step 740 of method 700, as described below. The purchase recommendation 425 may be determined by the input processor 317, as described above. In some embodiments, the purchase recommendation 425 is a recommendation for an amount of inventory (e.g., input) for the first entity to acquire. The recommendation for the amount of input for the first entity to acquire may correspond to a current throughput predicted based on the predicted individual throughput (e.g., the individual demand 415) and the current input (e.g., the current inventory 410).

The purchase recommendation 425 may include a target amount of inventory to acquire (e.g., 32 units). In some embodiments, the purchase recommendation 425 may include a range of inventory to acquire, including a low end (e.g., 24 units), the target amount (e.g., 32 units), and a high end (e.g., 40 units). In some embodiments, the purchase recommendation 425 includes one or more selectable elements configured to allow the user to confirm or deny the purchase recommendation 425. For example, a user may interact with a selectable element represented by a “YES” to proceed with a purchase of the target amount of inventory indicated by the purchase recommendation 425. As another example, the user may interact with a selectable element represented by a “NO” to reject proceeding with the purchase of the target amount of inventory indicated by the purchase recommendation 425. In some embodiments, upon rejecting the purchase recommendation 425, the user may be prompted with an option to enter a custom amount of inventory to purchase. In some embodiments, the option may include one or more suggested amounts of inventory to purchase based on the range provided by the purchase recommendation 425 (e.g., 24 units, 32 units, 40 units, etc.). In some embodiments, the option may include a custom entry field where the user can input the custom amount of inventory to purchase.

The interface 400 includes a display of the performance score 430. The performance score 430 may be determined by input processor 317. The input processor 317 may determine the performance score 430 by comparing an individual performance of the first entity to an overall performance of the market, an industry performance, a competitor performance, etc. The input processor 317 may retrieve input levels associated with one or more other entities. To determine an industry performance, for example, the input processor 317 may be configured to determine the input levels for a plurality of entities in an entire entity category (as categorized by the categorization engine 318). To determine the competitor performance related to a particular entity, the input processor 317 may be configured to determine the input levels for a plurality of entities in one or more sub-categories of the particular entity (as categorized by the categorization engine 318). For example, the individual performance of the first entity may relate to a sales performance over a specific period of time (e.g., one month, one year, five years, etc.) The input processor 317 may then compare this sales performance to an industry-wide sales performance. The industry-wide sales performance may be determined by retrieving the transaction histories associated with all of the entities categorized (e.g., by the categorization engine 318) in the same entity category as the first entity. In some embodiments, the performance score 430 may indicate a score out of a predetermined scale. For example, the performance score 430 may be 760 out of a 1000-point scale. In this case, a score of 1000 may indicate a perfect score (e.g., a performance at the top of the market). In some embodiments, the perfect score reflects that the performance of an entity exceeds the performance of each of the second entities associated with the competitor count 420.

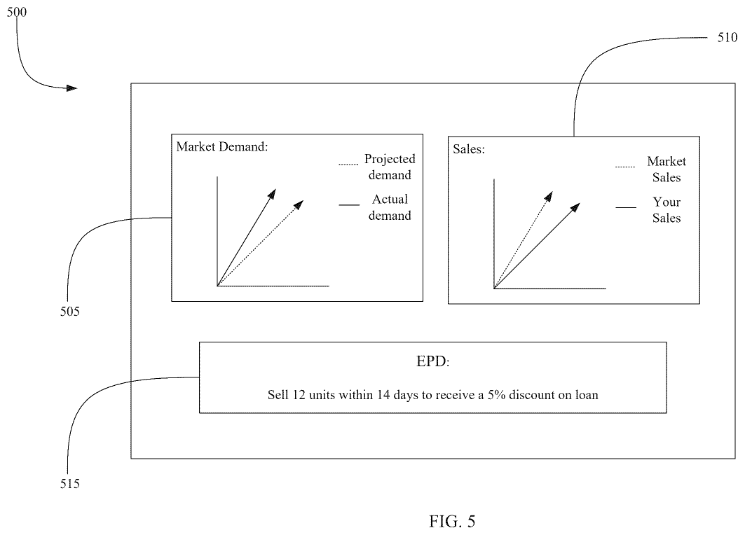

Referring now to FIG. 5, an interface 500 on a user device of an enterprise resource is shown according to an example embodiment. In some embodiments, the interface 500 is generated by the system 300 on the user device 340 of the enterprise resource 330. In brief, the interface 500 includes graphics displaying information relating to industry trends and entity performance and presents a discount offer (e.g., a discount offer from the financial institution). The graphics displayed on the interface 500 may be customizable by the user or by the institution computing system (e.g., the system 300). In the embodiment shown, the interface 500 displays a market demand 505, a sales performance 510, and an early paid discount (EPD) offer 515.

Still referring to FIG. 5 and in further detail, the interface 500 includes a graphical representation of the market demand 505. In some embodiments, the market demand 505 includes a projected demand (e.g., a predicted demand, etc.) and an actual demand (e.g., a realized demand, etc.). For example, the projected demand may be illustrated by a dashed line on the graphical representation of the market demand 505 and the actual demand may be illustrated by a solid line on the graphical representation of the market demand 505. In some embodiments, the projected demand may include the throughput analytics forecasted at step 720 of method 700, as described below. For example, the projected demand may be determined by the first AI model 103 based on the first data retrieved by the tagging engine 316, as described below. The actual demand may be a current market demand based on real-time data (e.g., from at least one of the first data source and the second data source) and may be higher than, the same as, or lower than the projected demand.

The interface 500 includes a graphical representation of the sales performance 510. In some embodiments, the sales performance 510 includes a market sales performance (e.g., a sales performance of the entity category of the first entity) and an individual sales performance (e.g., a sales performance of the first entity). The market sales performance may be determined by the input processor 317 based on a plurality of transaction histories and an amount of inventory levels associated with a plurality of entities from a specific entity category (e.g., categorized by categorization engine 318). The transaction histories may be retrieved from an internal data source of the financial institution (e.g., one or more data sources 320). The market sales performance may include an amount (e.g., a percentage, a ratio, a fraction, etc.) of inventory sold across the entity category out of the total amount of inventory circulating in the entity category over a period of time (e.g., one month, one year, five years, etc.). The individual sales performance may be determined by the input processor 317 based on the transaction history and the inventory levels associated with a particular entity. The individual sales performance may include an amount (e.g., a percentage, a ratio, a fraction, etc.) of inventory sold by the particular entity out of the total amount of inventory circulating in the particular entity over a period of time (e.g., one month, one year, five years, etc.). In some embodiments, the market sales performance may be illustrated by a dashed line on the graphical representation of the sales performance 510 and the individual sales performance may be illustrated by a solid line on the graphical representation of the sales performance 510.

The interface 500 includes the EPD offer 515. The EPD offer 515 may be determined by the processing circuit 310 and presented to a user accessing the enterprise resource 330. In some embodiments, the EPD offer 515 is based on at least one of the market demand 505 and the sales performance 510. For example, if the actual demand is higher than the projected demand, the processing circuit 310 may present the EPD offer 515 to the user via the interface 500. Similarly, if the market sales performance is higher than the individual sales performance, the processing circuit 310 may present the EPD offer 515 via the interface 500. In some embodiments, the EPD offer 515 may include a loan discount that the first entity may receive if the first entity sells a specific quantity of inventory within a specified time frame (e.g., “Sell 12 units within 14 days to receive a 5% discount on loan”). In some embodiments, the EPD offer 515 is sent as a notification (e.g., a push-notification, etc.) to the user via the user device 340 of the enterprise resource 330.

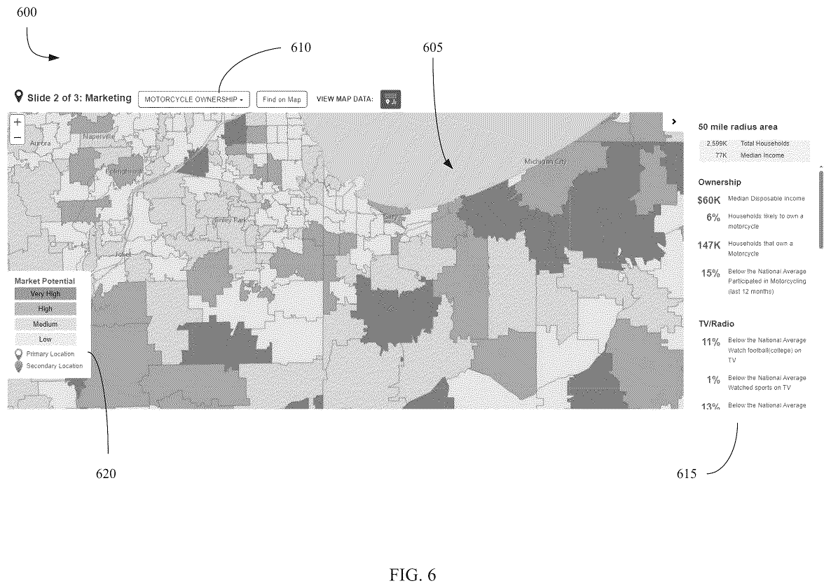

Referring now to FIG. 6, a heat map 600 is shown according to an example embodiment. In some embodiments, the heat map 600 is generated by the embedded service 335 and is shown on the user device 340 of the enterprise resource 330. The heat map 600 may be included on a user interface (e.g., the interface 400, the interface 500, etc.). The heat map 600 may be configurable such that a user can move the map (e.g., by dragging) and view additional geographical regions.

The heat map 600 may depict a regional area 605. As shown in FIG. 6, the regional area 605 may be divided into the counties included in that regional area 605. Each of the counties included in the regional area 605 may be selectable such that a user, upon selecting (e.g., clicking, tapping, etc.) one of the counties, may view data that is specific to that county. For example, the data that is specific to that county may include socioeconomic data associated with that county. In some embodiments, the regional area 605 includes the geographical location of the first entity. The regional area 605 may include a customizable radius. The customizable radius may be customized by a user via the user interface by interacting with a selectable element configured to adjust (e.g., expand, reduce) the regional area 605. In some embodiments, the heat map 600 reflects demographic data (e.g., data from the first data source, data from the second data source, etc.). The user may select the data shown by the heat map 600 from a drop-down menu of options 610. For example, the user may select “motorcycle ownership.”

In some embodiments, the heat map 600 includes a total number of households within the regional area 605 and a median income across the regional area 605. The total number of households and the median income may include data stored in at least one of the first data source (e.g., account information, transaction history, financial trends, etc.), and the second data source (e.g., private sector finance reports, government reports, census reports, etc.). The heat map may include a side panel 615 displaying a list of additional statistics based on the demographic data. The list of additional statistics may include one or more ownership statistics across the regional area 605 (e.g., a median disposable income, a percentage of households likely to own a motorcycle, a number of households that own a motorcycle, a percentage of participation in motorcycling relative to a national average over a 12-month period, etc.). The ownership statistics may include data from at least one of the first data source and the second data source. In some embodiments, the list of additional statistics includes one or more household entertainment statistics across the regional area 605 (e.g., a percentage of households watching college football on TV relative to a national average, a percentage of households watching sports on TV relative to the national average, etc.). The household entertainment statistics may be determined by at least one of the first data source and the second data source.

In some embodiments, the heat map 600 depicts a market potential 620 based on the demographic data. In some embodiments, the market potential corresponds to a market associated with the entity category of the first entity. In some embodiments, the market potential 620 is indicated using a color-coded legend. For example, a red region may correspond to a “very high” market potential, an orange region may correspond to a “high” market potential, a yellow region may correspond to a “medium” market potential, and a green region may correspond to a “low” market potential. The “very high” market potential may refer to a region where the demographic data suggests that a population of that region will have a very high demand for one or more products or product-types associated with the first entity. The “high market potential” may refer to a region where the demographic data suggests that a population of that region will have a high demand for one or more products or product-types associated with the first entity. The “medium” market potential may refer to a region where the demographic data suggests that the population of that region will have an average demand for one or more products or product-types associated with the first entity. The “low” market potential may refer to a region where the demographic data suggests that the population of that region will have a low demand for one or more products or product-types associated with the first entity. In some embodiments, the first entity may use the color-coded legend to identify a target region in which the first entity may focus its operation. The target region refers to a region where the population is predicted to have the highest demand for one or more products or product-types associated with the first entity (e.g., a red region). For example, the first entity may find an improved sales rate of its current inventory in the red region as compared to a sales rate of the current inventory in the yellow region.

Referring now to FIG. 7, a flow diagram of a method 700 for incorporating the industry trends engine into the enterprise resource platform is shown according to an example embodiment. In some embodiments, the method 700 is performed by the system 300. As a brief overview, at step 705, the institution computing system 300 establishes a connection with an embedded service within an enterprise resource of a first entity. At step 710, the authenticator 315 authenticates a user of the first entity. At step 715, the tagging engine 316 retrieves first data relating to the first entity and to other entities. At step 720, the first AI model (e.g., first AI model 103) forecasts throughput analytics based on the first data. At 725, the categorization engine 318 determines a count of second entities. At 730, the second AI model (e.g., second AI model 105) determines a predicted individual throughput for the first entity. At 735, the input processor 317 receives second data corresponding to a current input. At 740, the enterprise resource 330 generates a recommendation corresponding to a current throughput based on the individual throughput determined at 730 and the current input received at 735. The method 700 may be used to generate and display a graphical user interface indicative of the recommendation (e.g., interface 400, interface 500) and configured for rendering via the embedded service (e.g., the embedded service 335) within a user interface (e.g., the user interface 345) of the enterprise resource (e.g., the enterprise resource 330).

Continuing with FIG. 7 and in more detail, the method 700 begins when the institution computing system 300 establishes a connection with the embedded service 335 within the enterprise resource 330 of the first entity at 705. The first entity may be a dealer. In some embodiments, establishing the connection at 705 includes enrolling the first entity with the embedded service 335. Enrolling the first entity with the embedded service 335 may include an administrator of the financial institution accessing the embedded service 335 from a backend, generating a unique link associated with an account of the first entity, and transmitting the unique link to a user device associated with the first entity. In some embodiments, the unique link is encoded with an instruction for the embedded service 335 to perform services specific to the first entity. For example, the embedded service 335 may provide a micro-front end or a widget configured to interface with the enterprise resource 330 of the first entity through the user interface 345 of the user device 340.

In some embodiments, establishing the connection at 705 further includes tagging a profile associated with the first entity with one or more tags. The one or more tags refers to one or more identifying elements of the first entity. The one or more tags may be based on a set of attributes of the first entity (e.g., the one or more attributes tagged to the first entity by the tagging engine 316, as described above, with reference to FIG. 3). In some embodiments, the authenticator 315 receives the user account data upon authenticating a user of the first entity accessing the embedded service 335, as described below.

Upon tagging the profile associated with the first entity with the one or more tags, the categorization engine 318 may assign the first entity to an entity category based on the one or more tags applied to the profile at step 705. In some embodiments, the entity category is an industry in which the first entity participates (e.g., conducts business). By assigning the entity category to the first entity, the system 300 is trained to retrieve data relevant to the first entity when presenting industry trends.

The authenticator 315 may authenticate the user of the first entity accessing the embedded service 335 via the enterprise resource 330 at 710. In some embodiments, the authenticator 315 may authenticate the user by any of a plurality of authenticating methods. For example, the plurality of authenticating methods may include requesting credentials (e.g., an account number, a password, a pin code, etc.) or biometric information (e.g., a fingerprint, a hand scan, a vocal sample, a retina scan, etc.). In some embodiments, the user has a particular role within the first entity (e.g., a store manager, a sales associate, a company executive, etc.). The authenticator 315 may identify a set of responsibilities or access rights depending on the role of the user within the first entity. The authenticator 315 may be configured to grant more extensive access rights to the store manager than to the sales associate, for example.

The tagging engine 316 retrieves first data from one or more data sources at 715. In some embodiments, the tagging engine 316 retrieves the first data from the one or more data sources 320. For example, the first data may include information relating to other entities having one or more attributes corresponding to the set of attributes of the first entity, the geographic location of the first entity, and metrics associated with the entity category of the first entity (e.g., an industry performance). The other entities may be in the entity category of the first entity, may operate in a geographic area of the first entity, may sell substitute products to the type of product sold by the first entity, may sell complimentary products to the type of product sold by the first entity, etc. In some embodiments, the first data source stores at least some of the first data. In some embodiments, the second data source stores at least some of the first data.

The first AI model 103 forecasts throughput analytics (e.g., a market demand) at 720. Training of the first AI model 103 is described in greater detail above with reference to FIG. 1-FIG. 2 and also in greater detail below. In some embodiments, the throughput analytics correspond to a time window based on the first data (e.g., one week, two months, one year, etc.). In some embodiments, the throughput analytics may correspond to a demand associated with a resource (e.g., a product sold by the first entity, the type of product sold by the first entity, etc.) over the geographic area of the first entity.

In some embodiments, the first AI model 103 is a first AI model of the AI system 100. The first AI model 103 may be trained on data from a plurality of entities. The plurality of entities may be assigned to the entity category of the first entity. In some embodiments, the plurality of entities includes dealers, retailers, and manufacturers from the same industry as the dealer or from other industries (e.g., from industries that may sell the complementary products or the substitute products to the type of product sold by the first entity). In some embodiments, the first AI model 103 forecasts the throughput analytics using the first data.

The categorization engine 318 determines a count of second entities at 725. The count of second entities may satisfy selection criteria associated with the first entity. The selection criteria refers to one or more attributes of the first entity (e.g., the attributes tagged by the tagging engine 316). In some embodiments, the selection criteria correspond to the entity category of the first entity and to the geographic area corresponding to the first entity. For example, the count of second entities may represent the number of other dealers operating in at least one of the entity category or the geographic area of the first entity (i.e., competitors of the first entity). In some embodiments, the categorization engine 318 determines the count of second entities using data from at least one of the first data source or the second data source.

A second AI model 105 determines a predicted individual throughput (e.g., an individualized demand) for the first entity at 730. The predicted individual throughput refers to an estimated individual demand for a particular product or product-type associated with the first entity. In some embodiments, the individual throughput is calculated based on the count of second entities determined at 725 and on the throughput analytics forecasted at 720. The second AI model may be a generative AI model.

The input processor 317 receives second data corresponding to a current input (e.g., a product supply, a current inventory, etc.) at 735. The current input refers to an amount (e.g., a quantity, a number, a stock) of one or more products currently held at the first entity. The current input may be corresponding the throughput analytics forecasted by the first AI model at 720 and to historical inputs (e.g., a history of the product supply at the first entity). In some embodiments, the input processor 317 receives the second data from the enterprise resource 330 (e.g., via an exposed API from the ERP or a connection between the micro-front end and the ERP). In some embodiments, the input processor 317 receives the second data from the first data source. For example, the current input may be determined based on based on an outstanding PO, a count of outstanding loans against individual products, etc.

The enterprise resource 330 generates a graphical user interface (GUI) for rendering via the embedded service 335 at 740. In some embodiments, the enterprise resource 330 generates the GUI for rendering via the user interface 345 of the user device 340. The GUI may be configured with selectable elements or otherwise interactive elements with which the user can engage via the user device 340. In some embodiments, the GUI may resemble at least one of the graphical user interface of FIG. 4 (e.g., interface 400) or the graphical user interface of FIG. 5 (e.g., interface 500), as described in greater detail above. The GUI may display an output (e.g., the predicted individual throughput) generated by the second AI model.

The GUI may include a recommendation (e.g., purchase recommendation 425, as described in greater detail above, with reference to FIG. 4) corresponding to a current throughput of the first entity based on the predicted individual throughput determined at 730 and the current input determined at 735. In some embodiments, the GUI may present a score (e.g., performance score 430, as described in greater detail above, with reference to FIG. 4) corresponding to a current inventory of the first entity and the predicted individual throughput determined at 730. For example, a high score may indicate that the current inventory of the first entity exceeds the predicted individual throughput, an average score may indicate that the current inventory of the first entity meets the predicted individual throughput, and a low score may indicate that the current inventory of the first entity falls below the predicted individual throughput. In some embodiments, the GUI may include a heat map (e.g., heat map 600, as described in greater detail above, with reference to FIG. 6).

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web embodiments of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
establishing, by an institution computing system, a connection with an embedded service of the institution computing system within an enterprise resource of a first entity;
authenticating, by the institution computing system, a user of the first entity accessing the embedded service via the enterprise resource;
retrieving, by the institution computing system, first data from one or more data sources, wherein the first data comprises information relating to other entities having one or more attributes corresponding to attributes of the first entity, geographic data corresponding to the first entity, and metrics associated with an entity category corresponding to the first entity and the other entities;
forecasting, by a first artificial intelligence (AI) model of the institution computing system, throughput analytics for a time window based on the first data;
determining, by the institution computing system, a count of second entities which satisfy a selection criteria associated with the first entity, the selection criteria corresponding to the entity category of the first entity and the geographic data corresponding to the first entity;
determining, by a second AI model of the institution computing system, a predicted individual throughput for the first entity, according to the count of second entities and the throughput analytics for the time window;
receiving, by the institution computing system, second data corresponding to a current input corresponding to the throughput analytics, and historical inputs; and
generating, by the institution computing system, a graphical user interface for rendering via the embedded service within a user interface of the enterprise resource, the graphical user interface comprising a recommendation corresponding to a current throughput based on the predicted individual throughput and the current input.

2. The method of claim 1, further comprising:
enrolling, by the institution computing system, the first entity with the embedded service;
tagging, by the institution computing system, a profile associated with the first entity with one or more tags, based on the attributes of the first entity; and
assigning, by the institution computing system, the first entity to the entity category based on the one or more tags applied to the profile.

3. The method of claim 1, wherein the throughput analytics comprise a regional demand associated with a resource provided by the first entity and the second entities selected which satisfy the selection criteria.

4. The method of claim 1, wherein the one or more data sources comprises a first data source of the institution computing system and a second data source of a third-party computing system.

5. The method of claim 4, wherein the first data source stores at least some of the first data associated with the first entity, and second data corresponding to at least some of the second entities.

6. The method of claim 5, wherein the first AI model is trained on data from a plurality of entities, at least some of which are assigned to the entity category of the first entity, and wherein the first AI model forecasts throughput analytics using the first data retrieved from the first data source and the second data source.

7. The method of claim 1, wherein the graphical user interface comprises a range including the recommendation.

8. The method of claim 1, wherein the graphical user interface comprises a heat map associated with the geographic data corresponding to the first entity.

9. The method of claim 1, wherein the second AI model generates an output corresponding to the graphical user interface for rendering via the embedded service within the user interface of the enterprise resource.

10. The method of claim 1, wherein the second data corresponding to the current input is received from at least one of the enterprise resource or from a data source of the one or more data sources maintained by the institution computing system.

11. An institution computing system comprising:
a processing circuit comprising one or more processors and memory, the memory storing instructions that, when executed, cause the processing circuit to:
a connection with an embedded service of the institution computing system within an enterprise resource of a first entity;
authenticate a user of the first entity accessing the embedded service via the enterprise resource;
retrieve first data from one or more data sources, wherein the first data comprises information relating to other entities having one or more attributes corresponding to attributes of the first entity, geographic data corresponding to the first entity, and metrics associated with an entity category corresponding to the first entity and the other entities;
forecast, by a first artificial intelligence (AI) model of the institution computing system, throughput analytics for a time window based on the first data;
determine a count of second entities which satisfy a selection criteria associated with the first entity, the selection criteria corresponding to the entity category of the first entity and the geographic data corresponding to the first entity;
determine, by a second AI model of the institution computing system, a predicted individual throughput for the first entity, according to the count of second entities and the throughput analytics for the time window;
receive second data corresponding to a current input corresponding to the throughput analytics, and historical inputs; and
generate a graphical user interface for rendering via the embedded service within a user interface of the enterprise resource, the graphical user interface comprising a recommendation corresponding to a current throughput based on the predicted individual throughput and the current input.

12. The institution computing system of claim 11, wherein the instructions further cause the processing circuit to:
enroll the first entity with the embedded service;
tag a profile associated with the first entity with one or more tags, based on the attributes of the first entity; and
assign the first entity to the entity category based on the one or more tags applied to the profile.

13. The institution computing system of claim 11, wherein the throughput analytics comprise a regional demand associated with a resource provided by the first entity and the second entities selected which satisfy the selection criteria.

14. The institution computing system of claim 11, wherein the one or more data sources comprises a first data source of the institution computing system and a second data source of a third-party computing system.

15. The institution computing system of claim 14, wherein the first data source stores at least some of the first data associated with the first entity, and second data corresponding to at least some of the second entities.

16. The institution computing system of claim 15, wherein the first AI model is trained on data from a plurality of entities, at least some of which are assigned to the entity category of the first entity, and wherein the first AI model forecasts throughput analytics using the first data retrieved from the first data source and the second data source.

17. The institution computing system of claim 11, wherein the graphical user interface comprises a range including the recommendation.

18. The institution computing system of claim 11, wherein the second AI model generates an output corresponding to the graphical user interface for rendering via the embedded service within the user interface of the enterprise resource.

19. The institution computing system of claim 11, wherein the data corresponding to the current input is received from at least one of the enterprise resource or from a data source of the one or more data sources maintained by the institution computing system.

20. A non-transitory computer-readable medium storing instructions that, when executed by one or more processors of a processing circuit, cause the processing circuit to:
establish a connection with an embedded service of the institution computing system within an enterprise resource of a first entity;
authenticate a user of the first entity accessing the embedded service via the enterprise resource;
retrieve first data from one or more data sources, wherein the first data comprises information relating to other entities having one or more attributes corresponding to attributes of the first entity, geographic data corresponding to the first entity, and metrics associated with an entity category corresponding to the first entity and the other entities;
forecast, by a first artificial intelligence (AI) model of the institution computing system, throughput analytics for a time window based on the first data;
determine a count of second entities which satisfy a selection criteria associated with the first entity, the selection criteria corresponding to the entity category of the first entity and the geographic data corresponding to the first entity;
determine, by a second AI model of the institution computing system, a predicted individual throughput for the first entity, according to the count of second entities and the throughput analytics for the time window;
receive second data corresponding to a current input corresponding to the throughput analytics, and historical inputs; and
generate a graphical user interface for rendering via the embedded service within a user interface of the enterprise resource, the graphical user interface comprising a recommendation corresponding to a current throughput based on the predicted individual throughput and the current input.
